(19) United States
(12) Patent Application Publication
(10) Pub. No.: US 2012/0189974 A1
(43) Pub. Date: Jul. 26, 2012

(54) FISH BONE TRAY

(76) Inventor: Kyung Man Kang, Goyang-si (KR)

(21) Appl. No.: 13/498,169

(22) PCT Filed: Sep. 20, 2010
(86) PCT No.: PCT/KR2010/006467

§ 371 Date: Mar. 26, 2012

(30) Foreign Application Priority Data
Sep. 24, 2009 (KR) 10-2009-0090741

(51) Int. Cl. A61C 9/00

(52) U.S. Cl. 433/41

(57) ABSTRACT

The present invention provides a plastic dental impression acquisition bite tray having a metallic reinforcement inserted into a central connection link and a body area of an impression acquisition frame; and in particular, a dental impression acquisition bite tray in which the top, bottom, left and right walls of the impression acquisition frame are divided into plural parts at regular intervals with respect to an impression acquisition film such that the profile of the plastic dental impression acquisition bite tray is adaptively bent little by little in correspondence with the curvature of teeth alignment, thereby enabling the acquisition of an impression of any type of teeth. The plastic dental impression acquisition bite tray, having a handle to be held by an impression acquirer and an impression acquisition frame provided at one side of the handle, the impression acquisition frame being formed of a wall to support an impression material from the side during the acquisition of an impression, comprises: an impression acquisition film provided at the central portion of the impression acquisition frame, for providing a space to receive an impression material for the acquisition of an impression; and a metallic reinforcement inserted into a central connection link and the impression acquisition frame, wherein the top, bottom, left and right walls of the impression acquisition frame are divided into plural parts at regular intervals such that all or part of the profile of the dental impression acquisition tray can be freely deformed through adaptive bending by degrees to be in correspondence with the curvature of teeth alignment, thereby enabling the acquisition of an impression of any type of teeth.

### TECHNICAL FIELD

The present invention relates to a plastic dental impression acquisition bite tray, and more particularly, to a plastic dental impression acquisition bite tray which includes an impression acquisition film provided at the central portion of an impression acquisition frame for providing a space to receive an impression material for the acquisition of an impression and a metallic reinforcement inserted into a central connection link and the impression acquisition frame, wherein the top, bottom, left and right walls of the impression acquisition frame are divided into two to six parts at an interval of 0.5 to 3 mm such that the profile of the dental impression acquisition bite tray is adaptively bent little by little in correspondence with the curvature of teeth alignment, thereby enabling the acquisition of an impression of any type of teeth.

### BACKGROUND ART

Generally, an impression of teeth of a dental patient should be acquired to manufacture a dental prosthesis of the patient. A tool which is used to acquire the impression of upper jaw and lower jaw of teeth is called a bite tray.

A conventional dental impression acquisition bite tray includes a concave structure to receive an impression material to acquire internal impression structure of the mouth of a dental patient in which a dental prosthesis is mounted, and a handle fixed to the structure. The bite tray may be manufactured by blow molding, injection molding, compression molding or vacuum molding. In most dental clinics in Korea and advanced counties, a disposable bite tray is mainly used to acquire the impression of teeth for purposes of hygiene and convenience. Such disposable bite tray is manufactured by polypropylene as a kind of plastic or ABS material which is not expensive and easy to manufacture.

A conventional plastic bite tray into which a reinforcement is inserted and a normal plastic bite tray are classified into posterior, half side tray, sideless tray, anterior tray, quadrant tray, and full arch tray depending on the position of the acquisition of impression and the height of an impression acquisition frame. The aforementioned trays are collectively referred to as a bite tray in the industry and have the following defects.

The bite tray into which a metallic reinforcement is inserted has a tight impression acquisition frame c so that an occlusion surface is deformed during the acquisition of the impression of teeth. Thus, it is not easy to manufacture a suitable dental prosthesis.

In the plastic bite tray into which the metallic reinforcement is inserted or normal plastic bite tray, the impression acquisition frame is not freely deformed. Thus, the acquisition of the impression of dental patients whose teeth alignment is not straight or dental arch is bent is not possible. In this case, the impression of one side of the teeth is acquired by a normal omni tray or even if the impression of upper and lower jaws is acquired simultaneously but such impression is very standardized. Accordingly, the impression of teeth is not acquired fully or suitably.

### DISCLOSURE

### Technical Problem

The present invention has been made to solve the problems and it is an object of the present invention to provide a plastic dental impression acquisition bite tray which is formed by inserting a metallic reinforcement into the plastic, wherein an outside K of a central connection link is larger than an inside Q thereof so that the outside K is bent a little to make an impression acquisition film (nonwoven fabric) loose and tension is prevented from occurring from the impression acquisition film to thereby prevent deformation of the impression due to the impression acquisition film when the impression of teeth is acquired, the top, bottom, left and right walls of an impression acquisition frame are divided into two to six parts at an interval of 0.5 to 3 mm such that the profile of the plastic dental impression acquisition bite tray into which the metallic reinforcement is inserted is freely deformed in whole or in part through adaptive bending by degrees to be in correspondence with the curvature of teeth alignment and the profile of the tray is finely adjusted by dividing the walls of the impression acquisition frame into many parts, thereby enabling the acquisition of an impression of any type of teeth such as uneven teeth alignment or bent arch.

### Technical Solution

In order to achieve the object of the present invention, a plastic dental impression acquisition bite tray into which a metallic reinforcement is inserted, wherein a width of an impression acquisition frame for providing a space to receive an impression material is larger in an outside K than an inside Q so that the outside K is bent a little to make the impression acquisition film loose, and the top, bottom, left and right walls of the impression acquisition frame in which an impression material maintenance groove is formed are divided into two to six parts at an interval of 0.5 to 3 mm in a lengthwise direction such that the profile of the plastic dental impression acquisition bite tray is freely deformed in whole or in part and is adaptively bent little by little in correspondence with the curvature of teeth alignment to thereby enable the acquisition of an impression of any type of teeth.

### Advantageous Effect

As described above, a fish bone tray according to the present invention, and specifically, a plastic dental impression acquisition bite tray into which a metallic reinforcement is inserted, wherein the top, bottom, left and right walls of an impression acquisition frame in which an impression material maintenance groove is formed are divided into two to six parts at an interval of 0.5 to 3 mm such that the profile of the bite tray is freely deformed in whole or in part and is adaptively bent little by little in correspondence with the curvature of teeth alignment to acquire the impression of the teeth, and the width of the impression acquisition frame is manufactured to be large and is adjusted to be smaller during the acquisition of the impression of the teeth, and the impression acquisition film is loosened to prevent tension to thereby enable the acquisition of impression of any type of teeth.

### BRIEF DESCRIPTION OF DRAWINGS

FIG. 1 is a perspective view of a posterior fish bone tray of plastic dental impression acquisition bite trays into which a metallic reinforcement is inserted according to the present invention.

FIG. 2 is a plan view of a sideless fish bone tray of plastic dental impression acquisition bite trays into which a metallic reinforcement is inserted according to the present invention.

### DESCRIPTION OF REFERENCE NUMERALS OF MAIN PARTS IN DRAWINGS

A: fish bone tray

B: central connection link

K: outside of central connection link

Q: inside of central connection link

a: handle

b: handle reinforcing material

c: impression acquisition film (nonwoven fabric)

f: metallic reinforcement

g: walls by which the impression acquisition frame is divided

h: groove by which the impression acquisition frame is divided

### BEST MODE

Hereinafter, a fish bone tray according to an exemplary embodiment of the present invention will be described with reference to accompanying drawings.

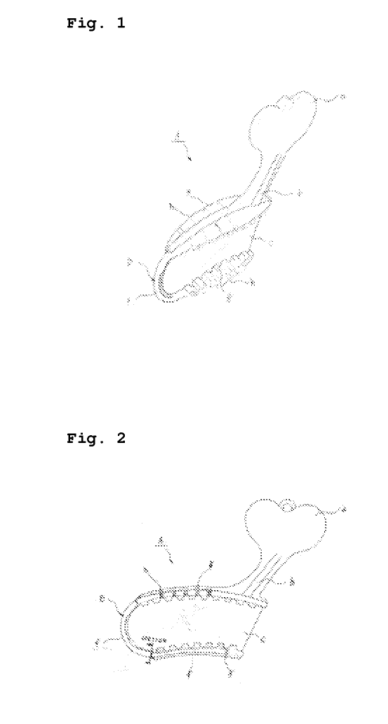

An impression acquisition film c is formed in a central portion of the bite tray with respect to a central connection link B in FIG. 1. A groove h divides the top, bottom, left and right walls of the impression acquisition frame into two to six parts at regular intervals. Through the groove h, a metallic reinforcement f is exposed to bend the tray easily, and the space is divided at an interval of 0.5 to 3 mm such that the profile of the bite tray is deformed as desired by a user and is adaptively bent little by little in correspondence with the curvature of teeth alignment to enable the acquisition of impression of any type of teeth. Thus, the more the impression acquisition frame is divided (segmented), the finer the profile of the bite tray is deformed (adjusted). To remove an intense tension of the impression acquisition film c, the outside K of the width of the impression acquisition frame is wider than the inside Q thereof such that the outside K is adjusted to be smaller to make the impression acquisition film c loose to thereby enable the acquisition of impression of teeth without deformation of an occlusion surface.

1. A plastic dental impression acquisition tray comprising a handle to be held by an impression acquired with his/her hand, an impression acquisition frame formed in the handle and an opposite side of the handle to support an impression material from the side, a reinforcement as reinforcing means to be inserted into and fixed to an external location of a connection link to which opposite impression acquisition frames are connected to be exposed outwardly, and an impression acquisition film provided at the central portion for providing a concave space to receive an impression material for the acquisition of an impression, wherein the top, bottom, left and right walls of the impression acquisition frame are divided into plural parts at regular intervals such that the profile of the dental impression acquisition bite tray is freely deformed in whole or in part and is adaptively bent little by little in correspondence with the curvature of teeth alignment to enable the acquisition of an impression of any type of teeth.

2. The fish bone tray for dental impression acquisition according to claim 1, wherein the space for dividing the impression acquisition frame is 0.5 to 3 mm.

3. The fish bone tray for dental impression acquisition according to claim 1, wherein the profile of the tray is finely deformed as the walls of the impression acquisition frame is divided into plural parts.

4. The fish bone tray for dental impression acquisition according to claim 1, wherein the space for dividing the impression acquisition frame exposes the metallic reinforcement.

5. The fish bone tray for dental impression acquisition according to claim 1, wherein the top, bottom, left and right walls of the impression acquisition frame are divided into two to six parts.

6. The fish bone tray for dental impression acquisition according to claim 1, wherein an external width of the impression acquisition frame is larger than an internal width thereof not to cause tension from the impression acquisition film.
